(19) United States
(12) Patent Application Publication
(10) Pub. No.: US 2007/0246233 A1
(43) Pub. Date: Oct. 25, 2007

(54) Thermal actuator for fire protection sprinkler head

(76) Inventor: A. David Johnson, San Leandro, CA (US)

Correspondence Address: SHAY LAW GROUP LLP, 2755 CAMPUS DRIVE, SUITE 210, SAN MATEO, CA, 94403, US

(21) Appl. No.: 11/731,508

(22) Filed: Mar. 29, 2007

Related U.S. Application Data
(60) Provisional application No. 60/788,866, filed on Apr. 4, 2006.

(51) Int. Cl. A62C 37/12

(52) U.S. Cl. 169/37; 169/42; 169/57

(57) ABSTRACT

A thermally actuated valve assembly. In some embodiments, the assembly includes a source of pressurized fluid, the source having an outlet; a valve at the outlet; a strut maintaining the valve closed against force applied by the pressurized fluid; and a thermal actuator formed at least in part from shape memory material, the thermal actuator being movable from a first shape permitting the strut to maintain the valve closed and a second shape applying force to move the strut, thereby permitting the pressurized fluid to open the valve.

### CROSS REFERENCE TO RELATED APPLICATIONS

This application claims the benefit under 35 U.S.C. § 119 of U.S. Provisional Patent Application No. 60/788,866, filed Apr. 4, 2006, which is incorporated by reference as if fully set forth herein.

### INCORPORATION BY REFERENCE

All publications and patent applications mentioned in this specification are herein incorporated by reference to the same extent as if each individual publication or patent application was specifically and individually indicated to be incorporated by reference

### BACKGROUND OF THE INVENTION

The present invention relates to fire safety devices, and more particularly to thermally actuated sprinklers commonly used in commercial and residential buildings.

Large numbers of thermally-actuated fire sprinklers are installed in structures every year. These sprinklers, generally installed in the structure's ceiling, are connected to a pressurized water supply and are intended to release the water into the room when the temperature in the room indicates that a fire or conflagration is taking place.

Multiple techniques have been used to actuator prior art fire sprinkler heads. Some prior art sprinkler valves bond two components together with alloys that melt at low temperatures. When heated above the melting temperature of the eutectic allow, the bond between the two components is released, and a control valve is permitted to open. This type of actuator is subject to failure as the solder ages and crystallizes, thereby weakening the bond.

A second type of prior art sprinkler valve uses a sealed glass tube nearly filled with a liquid that boils at a low temperature. As ambient temperature increases, the liquid boils, thereby raising the pressure inside the tube. At a high enough temperature the tube ruptures, permitting the sprinkler valve to open. Premature failure may occur, however, if the sprinkler head is subjected to mechanical shock and the tube is cracked.

Yet other prior art sprinkler valves incorporate shape memory components that change shape when a transition temperature is reached to actuate the sprinkler valve. Some such thermally actuated valves are described in U.S. Pat. No. 4,176,719; U.S. Pat. No. 4,549,717; U.S. Pat. No. 4,596,483; U.S. Pat. No. 4,706,758; U.S. Pat. No. 4,848,388; U.S. Pat. No. 5,494,113; U.S. Pat. No. 5,622,225; and U.S. Pat. No. 6,073,700.

### SUMMARY OF THE INVENTION

False triggering of sprinkler heads can cause damage that is expensive to repair and contributes to the cost of fire insurance. Thermally-actuated fire safety devices must meet strict codes.

The invention relates to a thermally actuated valve assembly with a thermal actuator made at least in part of a shape memory material and methods of operation of such valve assemblies. In one aspect of the invention, the invention provides a thermally actuated valve assembly comprising: a source of pressurized fluid, the source having an outlet; a valve at the outlet; a strut maintaining the valve closed against force applied by the pressurized fluid; and a thermal actuator formed at least in part from shape memory material, the thermal actuator being movable from a first shape permitting the strut to maintain the valve closed and a second shape applying force to move the strut, thereby permitting the pressurized fluid to open the valve. In some embodiments, the strut is collapsible and may be adapted to spring away from the valve when the thermal actuator is in the second shape.

In some embodiments, the strut has first and second support members attached by a hinge. The strut may also have a stay preventing the support members from bending about the hinge until a threshold bending force has been applied to the strut by the thermal actuator.

In some embodiments, the thermal actuator has a heat treated movable member formed at least in part from shape memory material, the movable member having a bent shape and a thermally actuated memory shape that is straighter than the bent shape, the movable member changing from the bent shape to the memory shape at a transition temperature. In some embodiments, the movable member includes a wire which may be longer in the memory shape than in the bent shape. In some embodiments the movable member also includes a contact member adapted to apply force to the strut when the movable member changes from the bent shape to the memory shape.

Another aspect of the invention provides a method of actuating a valve at an outlet of a pressurized fluid source, with the method including the following steps: maintaining a strut at the outlet to maintain the valve in a closed position preventing fluid to flow from the source through the outlet; heating a thermal actuator to a transition temperature; changing the shape of the thermal actuator from a first shape to a second shape in response to applying force to the strut; and moving the strut in response to the force, thereby permitting the pressurized fluid to open the valve.

In some embodiments, the thermal actuator is formed at least in part of shape memory material, the step of changing the shape of the thermal actuator including the step of creating a crystalline phase change in the shape memory material. In some embodiments, the first shape is longer than the second shape, and in some embodiments the second shape is straighter than the first shape.

In some embodiments, the moving step includes the step of collapsing the strut in response to the force and may include the further step of springing the strut away from the valve. In some embodiments, the strut comprises a hinge, and the moving step includes the step of bending the strut about the hinge. The strut may also include a stay resisting bending of the hinge, in which case the moving step includes the step of overcoming the stay's resistance.

In some embodiments, the thermal actuator includes a contact member, with the contact member applying force to the strut when the thermal actuator changes from the first shape to the second shape.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 is a front elevational view of a thermally actuated fire sprinkler valve assembly according to one embodiment of this invention.

FIG. 2 is a front elevational view of the thermally actuated fire sprinkler valve assembly of FIG. 1 in the process of being actuated.

FIG. 3 is a front elevational view of the thermally actuated fire sprinkler valve assembly of FIGS. 1 and 2 fully actuated.

### DETAILED DESCRIPTION OF THE INVENTION

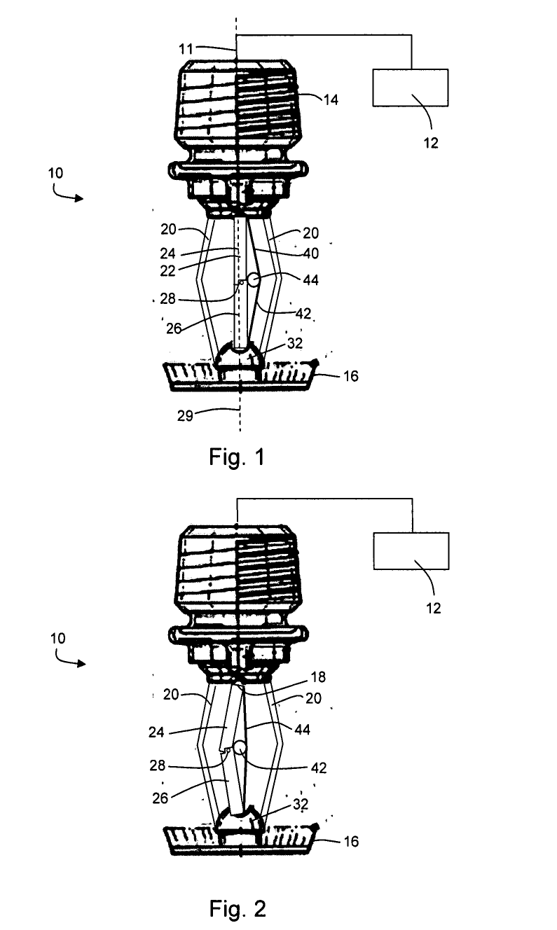

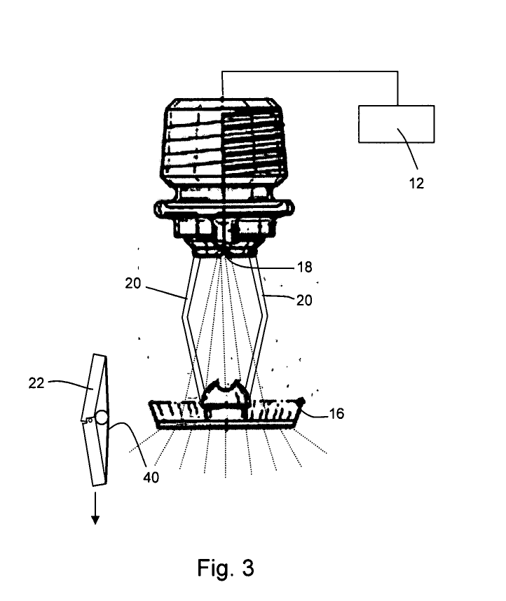

FIGS. 1-3 show one embodiment of the thermally actuated fire protection sprinkler valve assembly according to this invention. A sprinkler head 10 is connected to an outlet 11 of a source of pressurized fluid 12, such as water. Screw threads 14 may be provided for connection to the pressurized fluid source. The upper portion of sprinkler head 10 houses a valve, which is in its closed state in FIG. 1. A diverter 16 is held below a valve outlet 18 (shown in FIGS. 2 and 3) by a pair of arms 20.

The valve within the sprinkler head 10 is maintained in its closed state by a strut 22, as shown in FIG. 1, by, e.g., seating the top portion of the strut within the valve opening or by supporting a cover over the valve opening with the strut. In this embodiment, strut 22 is a hinged beam with beam elements 24 and 26 connected by a pivot or hinge 28 permitting bending in only one direction, in this embodiment, in the direction shown in FIG. 2. In the configuration shown in FIG. 1, fluid pressure from the valve exerts a downward force on strut 22 along dotted line 29, and strut 22 is oriented with respect to the valve outlet 18 so that hinge 28 must cross line 29 when strut 22 is bent. The alignment and shape of strut 22 with respect to the valve outlet 28 maintains strut 22 stably in position between valve opening 18 and a central hub 32 of diverter 16 despite the compressive downward load.

Also shown in FIG. 1 is a thermal actuator 40 formed from a shape memory element 42 (made, e.g., from Nitinol or other shape memory alloy) and a contact member 44. In this embodiment, the top and bottom of shape memory element 42 are attached to the top and bottom of strut 22, as shown, with contact member 44 disposed between shape memory element 42 and strut 22 at or near hinge 28.

Shape memory element 42 may be formed from a wire. Prior to assembly, the wire 42 is heat treated to a length approximating the straight length of strut 22 (i.e., the length shown in FIGS. 2 and 3). During assembly wire 42 is lengthened (pre-strained) to the length shown in FIG. 1, a length several percent greater than the length shown in FIGS. 2 and 3, and attached to the two ends of strut 22. Wire 42 maintains this length until it is heated to its characteristic crystalline phase change transition temperature (due, e.g., to hot gas from a fire), at which point wire 42 contracts to its “remembered” length and shape. When it does so, the center of wire 42 and contact member 44 move toward strut 22, as shown in FIG. 2. Contact member 44 acts as a fulcrum pushing against strut 22 and bending it around hinge 28 against the force exerted by the fluid pressure on strut 22. As hinge 28 passes through line 29, the downward force of the fluid pressure at valve outlet 18 collapses strut 22 so that it springs out entirely, thereby enabling fluid to exit valve outlet 18 without obstruction or interference, as shown in FIG. 3.

Strut 22 may be fabricated (e.g., by stamping) of a low mass metal or plastic so that is will not be affected by mechanical shock. An adjustment screw may be provided in the diverter hub 32 to adjust the initial compressive force on strut 22. The contact member 44 may be a plastic or glass fulcrum shaped so as to be held between the strut and the shape memory element, and glue or plastic may be placed on the contact member to hold it in place against vibration. A stay, such as a patch of frangible material, may be placed over the hinge such that the frangible material must be fractured before the hinge may be displaced significantly.

In some embodiments, the thermal actuator and strut can be contained in a space of about one inch by one-quarter inch by 1/16 inch, thereby fitting into existing commercial sprinkler heads. Other dimensions of the strut and thermal actuator can be computed as follows: Assuming a contraction of 3% as the shape memory element is heated through its transition temperature, if the strut is 2 cm long and the contact member or fulcrum is 2.5 mm in diameter, the linear movement of the shape memory element and contact member toward the strut can be as much as 2 mm.

What is claimed is:

1. A thermally actuated valve assembly comprising:
a source of pressurized fluid, the source having an outlet;
a valve at the outlet;
a strut maintaining the valve closed against force applied by the pressurized fluid; and
a thermal actuator formed at least in part from shape memory material, the thermal actuator being movable from a first shape permitting the strut to maintain the valve closed and a second shape applying force to move the strut, thereby permitting the pressurized fluid to open the valve.

2. The valve assembly of claim 1 wherein the strut is collapsible.

3. The valve assembly of claim 1 wherein the strut is adapted to spring away from the valve when the thermal actuator is in the second shape.

4. The valve assembly of claim 1 wherein the strut comprises first and second support members attached by a hinge.

5. The valve assembly of claim 4 wherein the strut further comprises a stay preventing the support members from bending about the hinge until a threshold bending force has been applied to the strut by the thermal actuator.

6. The valve assembly of claim 1 wherein the thermal actuator comprises a heat treated movable member formed at least in part from shape memory material, the movable member having a bent shape and a thermally actuated memory shape that is straighter than the bent shape, the movable member changing from the bent shape to the memory shape at a transition temperature.

7. The valve assembly of claim 6 wherein the movable member comprises a wire.

8. The valve assembly of claim 7 wherein the wire is longer in the memory shape than in the bent shape.

9. The valve assembly of claim 6 wherein the movable member further comprises a contact member adapted to apply force to the strut when the movable member changes from the bent shape to the memory shape.

10. A method of actuating a valve at an outlet of a pressurized fluid source, the method comprising:
maintaining a strut at the outlet to maintain the valve in a closed position preventing fluid to flow from the source through the outlet;
heating a thermal actuator to a transition temperature;
changing the shape of the thermal actuator from a first shape to a second shape in response to apply force to the strut; and
moving the strut in response to the force, thereby permitting the pressurized fluid to open the valve.

11. The method of claim 10 wherein the thermal actuator comprises shape memory material, the step of changing the shape of the thermal actuator comprising creating a crystalline phase change in the shape memory material.

12. The method of claim 11 wherein the first shape is longer than the second shape.

13. The method of claim 11 wherein the second shape is straighter than the first shape.

14. The method of claim 10 wherein the moving step comprises collapsing the strut in response to the force.

15. The method of claim 14 wherein the moving step further comprises springing the strut away from the valve.

16. The method of claim 10 wherein the strut comprises a hinge, the moving step comprising bending the strut about the hinge.

17. The method of claim 16 wherein the strut further comprises a stay resisting bending of the hinge, the moving step comprising overcoming the stay resistance.

18. The method of claim 10 wherein the thermal actuator comprises a contact member, the contact member applying force to the strut when the thermal actuator changes from the first shape to the second shape.
